(19) United States
(12) Patent Application Publication
(10) Pub. No.: US 2016/0200420 A1
(43) Pub. Date: Jul. 14, 2016

(54) SYSTEM AND METHOD FOR UNWANTED FORCE REJECTION AND VEHICLE STABILITY

(71) Applicant: AURORA FLIGHT SCIENCES CORPORATION, Manassas, VA (US)

(72) Inventors: TERRENCE MCKENNA, Cambridge, MA (US); J. SEAN HUMBERT, College Park, MD (US); RHOE ANTHONY THOMPSON, Navarre, FL (US)

(21) Appl. No.: 14/865,706

(22) Filed: Sep. 25, 2015

Related U.S. Application Data
(60) Provisional application No. 62/055,499, filed on Sep. 25, 2014.

(51) Int. Cl. B64C 13/16; B64C 3/56; B64C 9/18

(52) U.S. Cl. CPC B64C 13/16; B64C 9/18; B64C 3/56

(57) ABSTRACT

An aircraft comprising a fuselage and a plurality of wings. The fuselage may be positioned between a first wing and a second wing, wherein said first wing and said second wing each comprise (a) a plurality of sensors and (b) a plurality of flaperons. A flight controller may be configured to (1) receive measurement data from each of said plurality of sensors and, (2) independently actuate each of said plurality of flaperons.

This application claims priority to U.S. Patent Appln. No. 62/055,499, filed Sep. 25, 2014, the contents of which are incorporated herein by reference.

### STATEMENT OF GOVERNMENT INTEREST

This invention was made with government support under Contract Number: FA8651-13-C-0017 awarded by United States Air Force. The government has certain rights in the invention.

### FIELD OF THE INVENTION

This present invention generally relates to autonomous vehicle navigation, and, more specifically, to techniques for providing gust rejection and increasing vehicle stability using proprioceptive sensing techniques.

### BACKGROUND

Small aircraft and unmanned aerial vehicles (UAVs), particularly those intended for use in urban or otherwise cluttered environments, face extreme constraints in regards to stability of the aircraft's state (e.g., attitude and position) when faced with atmospheric turbulence and gusts. For example, small, unmanned aerial vehicles (SUAVs) are often subjected to asymmetric gusts caused by the channeling and occlusions of flow in urban canyons—flow fields unique to this environment. Indeed, poor gust rejection is more dire due to higher probabilities for collision, vehicle loss, and mission failure, especially where the margins on position and attitude state tracking are much smaller. For example, when navigating urban canyons, a 1-2 meter offset in course could lead to obstacle collision, mission failure, or vehicle loss. Moreover, gust rejection and vehicle stability is crucial for generating clear and understandable surveillance video, a primary mission of these small aircraft. Furthermore, these same aircraft can greatly benefit from gust rejection through increased maneuverability, flight envelopes, and performance.

Small UAVs are often subjected to stringent requirements on payload stability and vehicle maneuverability while also driving vehicles to smaller sizes and payload capacities. Given the tight resource constraints on SUAVs, the challenge is not just to enable these capabilities, but also to implement them within a package that meets constraints on size, weight, and power (SWaP). Thus, gust rejection is particularly difficult to achieve on smaller platforms due to actuator limitations and latency/noise properties from traditional inertial sensors such as gyroscopes (latency due to platform dynamics) and accelerometers (noisy measurements).

Given the apparent contradiction between a demand for increased autonomy and performance, and the miniaturization of the platform and sensing system, a need exists for improved systems and methods for providing gust rejection and increasing vehicle stability via, for example, proprioceptive sensing techniques.

### SUMMARY

Improved systems and methods for providing gust rejection and increasing vehicle stability via, for example, proprioceptive sensing techniques.

According to a first aspect, an aircraft comprises: a fuselage; a plurality of wings, wherein the fuselage is positioned between a first wing and a second wing, wherein said first wing and said second wing each comprise (a) a plurality of sensors and (b) a plurality of flaperons; and a flight controller, wherein the flight controller is configured to (1) receive measurement data from each of said plurality of sensors and, (2) independently actuate each of said plurality of flaperons.

In certain aspects, said one or more of said plurality of sensors provide torque measurement data.

In certain aspects, the flight controller is configured to detect an unwanted force imparted upon the aircraft via said one or more of said plurality of sensors.

In certain aspects, in response to a detection of an unwanted force, the flight controller actuates one or more of said plurality of flaperons so as to counter the effect of the unwanted force.

In certain aspects, at least one of said plurality of sensors is a strain gauge.

In certain aspects, said strain gauge is a fiber optic strain gauge embedded within a groove of said first wing or said second wing.

In certain aspects, said first and second wings are fabricated using Fused Deposition Modeling (FDM).

In certain aspects, said plurality of sensors is positioned along the leading edge of said first and second wings.

In certain aspects, said flight controller uses spatial weighting patterns to convert instantaneous strain patterns to feedback commands.

In certain aspects, said flight controller uses an optimization routine to choose a deflections for each of said plurality of flaperon to achieve a desired wing profile for said first wing or said second wing.

In certain aspects, a separator is positioned between said fuselage and said first wing or said second wing, said separator having a sensor positioned thereon. Said sensor may be a strain gauge and said separator may be fabricated using a grade G-10 phenolic material.

### BRIEF DESCRIPTION OF THE DRAWINGS

The foregoing and other objects, features, and advantages of the devices, systems, and methods described herein will be apparent from the following description of particular embodiments thereof, as illustrated in the accompanying figures, where like reference numbers refer to like structures. The figures are not necessarily to scale, emphasis instead being placed upon illustrating the principles of the devices, systems, and methods described herein.

FIGS. 1a and 1b illustrate an example aircraft having p-wings.

FIGS. 2a through 2d illustrate an example aircraft having canted hinge wings.

FIG. 3a illustrates an example inner loop diagram.

FIG. 3b illustrates an example servo dynamics block.

FIGS. 4a through 4d illustrate results of a thermal encounter.

FIGS. 5a through 5c illustrate attitude deviations during the thermal traverse.

FIGS. 6a through 6c illustrate results for relatively light turbulence.

FIGS. 7a through 7d show the surface deflections required to achieve the given tracking results.

### DETAILED DESCRIPTION

Preferred embodiments of the present invention will be described hereinbelow with reference to the accompanying drawings. In the following description, certain well-known functions or constructions are not described in detail since they would obscure the invention in unnecessary detail.

The present invention is generally directed to improved systems and methods for providing gust rejection and increasing vehicle stability via, for example, proprioceptive sensing techniques. As will be appreciated from the following specification, proprioceptive sensing techniques may be used in conjunction with the aircraft's autopilot to leverage a high bandwidth, local inner loop feedback of spatially weighted strain measurements to generate commands that ensure commanded forces and moments are applied to the vehicle in the presence of atmospheric disturbances (e.g., gusts). Such systems and methods further reduce noise (e.g., through instantaneous spatial averaging) and improve closed loop bandwidth and loop latency via, for example, direct measurements of force and moment instead of the platform rigid body motion without the use of a dynamic filter.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “side,” “front,” “back,” and the like, are words of convenience and are not to be construed as limiting terms.

An objective of the present disclosure is to provide a novel aircraft and aircraft system that incorporate bio-inspired actuation and articulation concepts and proprioceptive sensing techniques. Such a novel design may employ a tight sub-system that integrates sensing and actuation to enable unparalleled stability and maneuverability for an aircraft, such as a small unmanned aerial vehicle (SUAV). That is, the proprioceptive sensing techniques may use load feedback to enable “load servoing” (e.g., modulation of control surfaces to achieve desired moments and/or forces on the fuselage). By implementing a feedback loop on the actual force or moment output of the lifting surface, systems and methods disclosed herein may provide higher bandwidth rejection of gusts and other disturbances by reducing measurement latencies and using feedback to provide robustness to aerodynamic uncertainties. Such uncertainties can occur due to operation in complex aerodynamic regimes, (e.g., low Reynolds (Re) number effects, such as separation bubbles, vortex lift, stalled surfaces, or complex interacting surfaces), incomplete modeling, or aerodynamic surface damage.

As will be discussed below, testing indicates that wings that incorporate such proprioceptive measurement and feedback of their aerodynamic or load state to significantly improve the performance of aircraft in a regime where they are currently severely deficient—that is, their ability to penetrate winds and reject gusts, to operate consistently with less accurate aerodynamic models, and to continue to fly effectively after the damage that commonly occurs in field use. Such robustness to damage would also benefit urban clutter navigation concepts that rely on surviving occasional collisions, as insects and birds do. The present systems and methods provide a number of advantages. For example, improving: (1) signal-to-noise ratio of extracted state data through spatial weighting/averaging across sensors, and (2) disturbance rejection capability of disturbances at the plant input on the plant output. The present systems and methods further reduce (1) modeling effort for control design due to improved robustness with respect to plant uncertainty (aerodynamic/stability derivatives/actuator models); (2) latency and improve closed loop bandwidth and gust rejection capabilities; and (3) controller complexity because no gain scheduling is required. Indeed, current systems and methods fail to address how vehicle design would change to take advantage of the new sensing means, such as the presently disclosed bracket that spans between the wings isolates roll-torsional loads, distributed ailerons, and tight sub-system integration. The present systems and methods provide a gust rejection control system suitable for use with UAV/micro air vehicle (MAV) and/or small commercial aviation platforms. The gust rejection control system may be integrated with exiting aircraft via a retrofit (e.g., via software update and/or by (a) adding a sensor array to an existing wing, or (b) replacing the wing).

Aircraft Designs. Wings that incorporate such proprioceptive measurement and feedback of their aerodynamic or load state to achieve a more effective lift-producing device will generally be referred to as proprioceptive wings, or abbreviated as P-Wings. As will be discussed below, such proprioceptive wings may be used to reject gusts in SUAVs by measuring, for example, the distribution of airflow velocity and angle of attack across the wing, and subsequently actuating a set of span-wise flaps. In other words, a p-wing can detect a disturbance (e.g., an unwanted force imparted on the aircraft, such as a gust) using one or more sensors positioned on the wing, and counter the disturbance via one more actuator-controlled flight surfaces. The sensed forces may further be used to compensate for latency in angular rate sensors or to adapt actuator positions to compensate for system uncertainty and sensor bias.

Considerations when implementing P-Wings may include the use a limited number of sensors, implemented in tight, simple control loops to enable outer loops to be designed with less knowledge of the inner-loop dynamics, much as current control systems rely on the servos to deliver consistent performance over their range of operation, even though the underlying components may exhibit performance variations due to manufacturing variations, loads, and heating. However, such considerations can be customized to a particular vehicle configuration to address specific situations with the SUAVs.

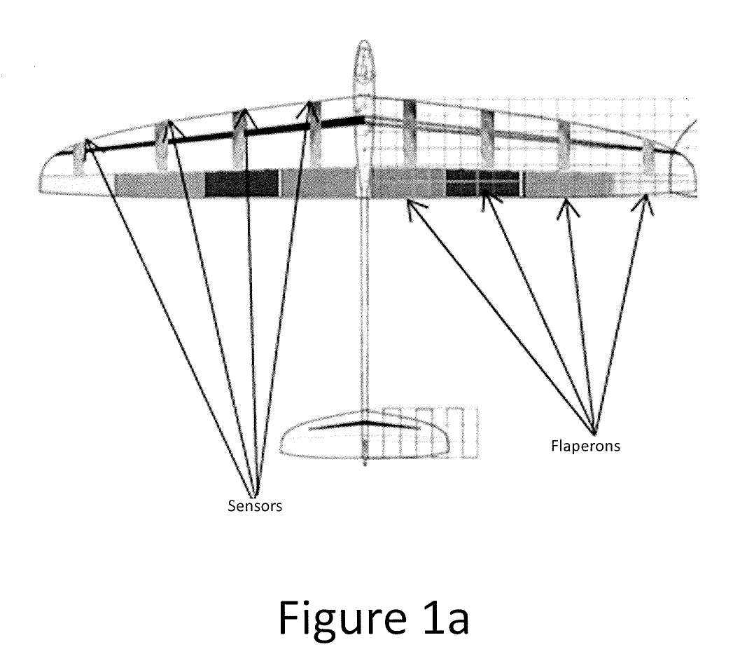

As illustrated in FIG. 1a, rather than a single conventional aileron configuration, a P-Wing may use a plurality of span-wise distributed, independently actuated, ailerons (e.g., wing-borne control surfaces), or “flaperons.” Generally speaking, a flaperon is a type of aircraft control surface that combines aspects of both flaps and ailerons. In addition to controlling the roll or bank of an aircraft, as do conventional ailerons, both flaperons can be lowered together to function similarly to a dedicated set of flaps. Similarly, both ailerons could also be raised, which would give spoilerons. The flaperon may incorporation on types of flaps or flap features, including, without limitation, plain, split, slotted, Fowler, Junkers Flap Gouge, Fairey-Youngman, Zap, Krueger, Gurney, and, in certain aspects, leading edge flaps, such as leading edge droop and blown flaps.

The wing may utilize a continuous set of sensors (e.g., strain/torque measurement sensors) along the wing to manipulate the span-wise, continuous, trailing edge surface (e.g., the flaperons), much in the way a bird is known to alter its wing shape. For instance, if the wing is outfitted with four flaperons per wing spanning 0-25%, 25-50%, 50-75% and 75-100% of the wing (versus a single aileron spanning 0-100%), the control system could localize the gust response and actuate only the affected flaperon. This actuation scheme, coupled with additional torque measurements along the span, provided greater attitude stabilization over the use of torque feedback alone. Improvements in the off-axis states were most apparent by enabling better management of the yawing moments and lift forces in the face of roll-inducing asymmetric gusts. For example, FIG. 1a illustrates an aircraft having, on each side of the fuselage, a wing having four flaperons and four sensors positioned along the span. However, it is contemplated that fewer flaperons and sensors may be used on each wing, or, to provide greater localization, a greater number of flaperons and sensors. The number of flaperons and sensors may also depend on the size of the wing. For example, a longer wing provides additional space for additional flaperons and sensors.

Indeed, independently actuated flaperons achieve much finer resolution on the span-wise lift profile of the wing than conventional ailerons alone. Coupled with the span-wise torque measurements, effective rejection of localized gusts is now possible enhancing stability and ensuring parts of the wing do not become overloaded. Thus, flight states (e.g., altitude, yaw rate, and heading) will be much less affected by an asymmetric gust if the baseline lift vs. span curve is substantially maintained. Such independently actuated flaperons (or other control surfaces) and span-wise sensors (e.g., torque or strain sensors) may facilitate a dynamic control technique that uses feedback proportional to forces and moments of an airframe to deal with control uncertainty and increase airframe performance. Such a technique can allow for improved ability to compensate for any disturbances imposed on the aircraft by the environment, adapt to changes in flight vehicle characteristics, and minimize dependence on model-based control constructs.

Furthermore, with a distributed actuation scheme, the lift characteristics can be maintained with only torque feedback and with no need for complex aero modeling. Utilizing span-wise, distributed torque readings and independently controlled, actuated flaperons on a wing, optimization routines may be employed to select precise deflections for each available aileron to achieve a desired span-wise torque, viz, lift, and profile on the wing. Moreover, the placement (e.g., position and orientation) of the sensors on the wing may be optimized for each specific aircraft or aircraft type to maximize performance. The span-wise, distributed torque readings may be further used to control one or more spoilers, which may be used to create drag.

As illustrated in FIG. 1a, local flow velocity and angle of attack may be measured at a plurality of points (e.g., two to eight points) along the span of a typical low-Re vehicle. As wind velocity and angle of attack vary, a wing with appropriate feedback to flaperons can vary its camber angle as a function of the span at high bandwidth to maintain desired lift (disturbance rejection). However, modulating wing lift coefficient to maintain constant lift may result in non-negligible changes in the wing's pitching moment, which must be counteracted (e.g., using the horizontal tail). To do so, either optimization in a model-based approach, or a “moment servo” loop on elevator deflection, with feed-forward of average flap deflection, may be used.

In certain aspects, the wing may be fabricated using Fused Deposition Modeling (FDM), or 3D printing, to embed the sensors (e.g., fiber optic strain gauges) within micro-grooves or notches. Further, the sensors may be embedded in the top and/or bottom of the wing to obtain numerous torque measurements for use in stabilization. The placement of the grooves may be determined to ensure that the fiber optic sensor yields evenly distributed, span-wise measurements, in addition to measurements for precise locations. The placement of the grooves may be determined by so as to faciliated even distribution of sensor measurements. A benefit of this fabrication method is that it produces a high-performing, more stable aircraft, using advanced sensing and 3D printing disciplines.

FDM is a thermal polymer layer deposition process that produces parts one layer at a time, effectively printing aircraft components rapidly, in low-volume, and to exacting material specifications. Using FDM, numerous wing design iterations may be inexpensively manufactured to meet desired strength and stiffness requirements, control surface sizing, and other characteristics. Further, additional wings may be fabricated to allow for tailored sensor integration, ease of generating additional actuation schemes or altering the control surface placement, ease of characterizing the strain on the wing, and an ability to easily alter the wing's stiffness to provide the best platform for proprioceptive sensing in a given application. This capability also offers robustness against wing damage, as replacement components are readily reproducible.

While FIG. 1a illustrates a wing having a plurality of sensors positioned along the leading edge, torque measurements may also be obtained (in addition to or in lieu of the leading edge) using a plastic separator positioned between the wing and the fuselage. For example, as illustrated in FIG. 1b, sensors may be integrated with an aircraft at the connection points between the various aircraft component to detect strain or torque imparted. For example, strain gauges may be integrated with an aircraft (e.g., as tested, in a foam glider having a 20″ wing span) such that the wings are separated from the fuselage using one or more plates, each plate may have one or more strain gauges positioned thereon. The plates may be fabricated from a semi-flexible material such as, for example, plastic (or a composite material). For example, a suitable semi-flexible material may include grade G-10 phenolic, continuous filament, woven glass fabric, which is approximately one-half the weight of aluminum with a physical toughness that resists abrasion, friction, impact, and material fatigue. More specifically, FIG. 1b illustrates an aircraft having five stress sensors arranged at points around the fuselage that provide information about forces and moments on the aerial vehicle. This configuration is particularly useful for implementations in which calculating the load on the wing, and in turn the lift, is important, as it is relatively straightforward to characterize the load distribution and material properties of the plate.

The ease of constructing different wing types using the methods disclosed herein facilitates the use of bio-inspired geometries and actuation schemes that could further improve aircraft performance when using proprioceptive sensing. For instance, using proprioceptive sensing, feedback pathways, and sensing modalities of insects and birds can be used to develop unconventional wing designs with integrated sensors that can further extend our biological insight. In other words, nature's fliers provide the best response in turbulent environments enabled by both their sensing capabilities as well as their “vehicle” design. Additionally, bio-inspired actuation schemes may provide other desirable qualities present in nature, like damage redundancy.

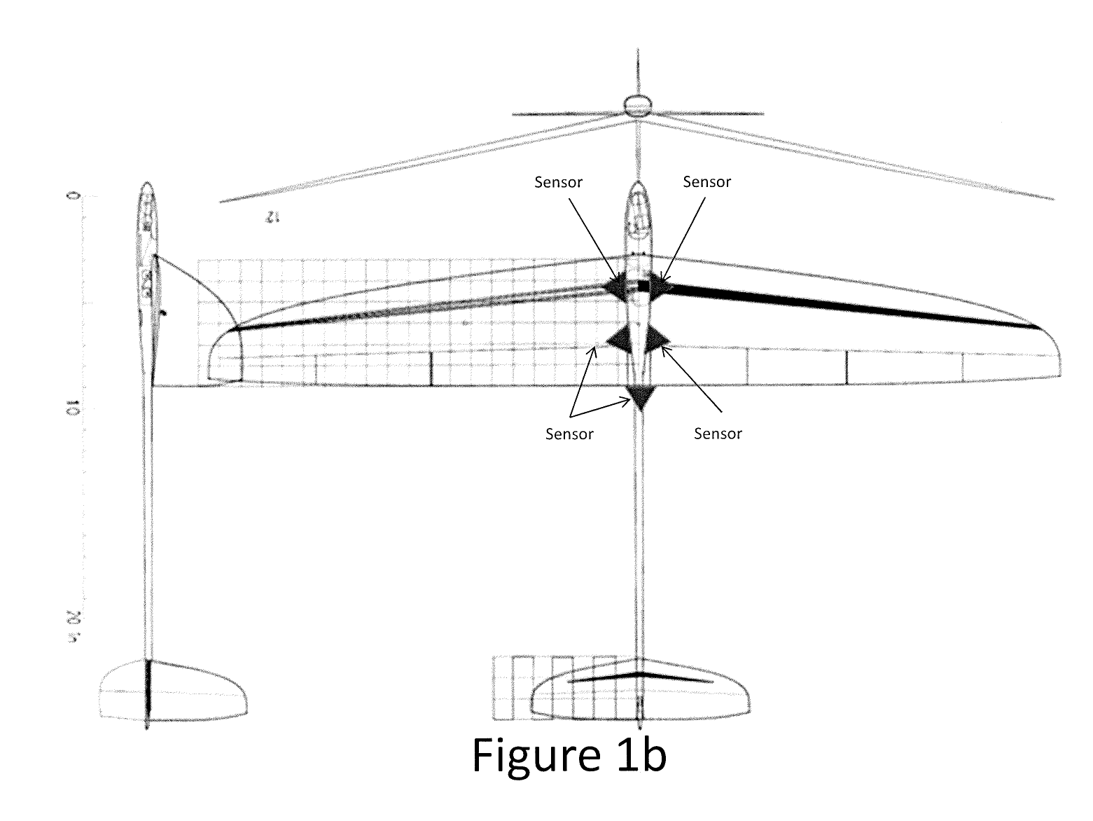

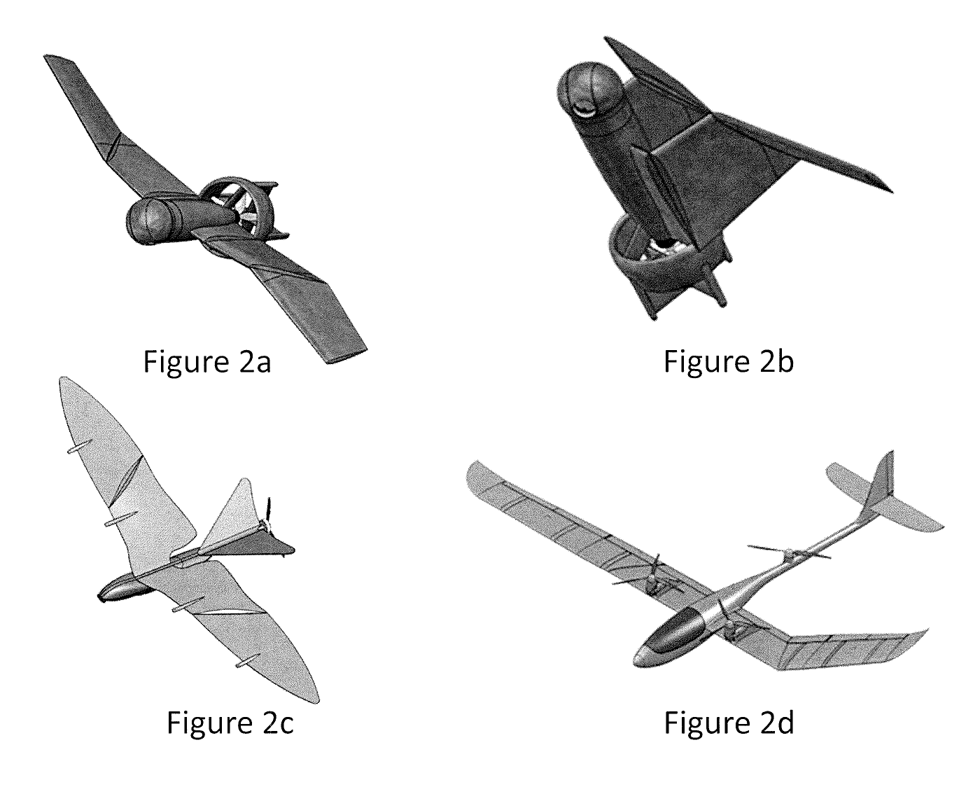

Canted Wings. While FIGS. 1a and 1b illustrate traditional fixed wings, additional example wing designs suitable for P-wing functionality are shown in FIGS. 2a through 2d. Specifically, the aircraft illustrated in FIGS. 2a through 2d employ a canted hinge concept, which changes the angle of attack of the outboard wing section as the wing bends (or folds). The canted hinge, which may be independently actuated, may also provide other potential properties such as reconfigurability for perch maneuvering, and passive gust load rejection, through compliance in the hinge. Such aircraft facilitate bio-inspired mechanisms to modulate lift through canted, actuated wing bends, which allow direct control of the angle of attack of outboard wing panels. Combined with shoulder joints, these wing bends also allow for controlled wind penetration and gust rejection. Perch maneuvering may be enabled by maintaining outboard wing panels in an un-stalled, controllable-lift state during thrust-vectored perch maneuvering. Sensing loading using joint-mounted sensors would enable precise control of lift.

Canted wing bends are facilitated using hinged joints in the wing that are servo-actuated; changing the wing bend angle has two effects. The first is due to the wing cant; “folding” the wing downward across the joint decreases the outboard angle of attack, folding the wing upward increases the angle of attack. Thus, very large modulation of the wing lift to reject gusts is possible. The second effect involves combined, symmetrical shoulder and outboard joint deflection: the overall planform (when viewed from the top) decreases as the wing is folded into a steeper ‘M’ shape. This increases the wing loading, increasing trim velocity. Penetrating winds (i.e., rejecting wind shear) can be achieved in this way. Full (90°) deflection of the shoulder joint combined with 90° deflection of the outboard joint creates yet another flight mode, shown in FIG. 2b: this configuration still rejects gusts using outboard wing angle, but relies heavily on thrust vectoring for low-speed trim and control. Advantages of canted-hinge P-Wings, may include, for example, (1) effective gust rejection in perch maneuvering, (2) introduction of larger lift variations when compared to using flaps alone, (3) two-segment load balancing instead of one-segment (i.e., a more distributed approach), (4) using a variable-compliance shoulder joint to implement an active/passive approach, and (5) generating side forces as well as lift and moment.

Sensor Array. As discussed above, to facilitate P-Wing functionality, sensor arrays may be positioned on the wings to sense shear flow variations around the airfoil leading edge, and employ specialized processing to deduce stagnation point, separation point, and other “critical points”; these are sufficient to deduce local angle of attack, in other words, direct, high-bandwidth information about the wing-distributed aerodynamic state. Example sensors that can provide proprioceptive-like sensing include, for example, strain gauges and accelerometers. In certain applications, low noise is a consideration when selecting a strain gauge. Accordingly, strain gauge models that exhibit the lowest noise may be preferred. Further, while an analog strain gauge yields an extremely high bandwidth, once the conversion from analog to digital and various processing routines has been performed, the effective bandwidth the control system would see would be much lower. Thus, a digital strain gauge may be employed.

While the initial torque feedback implementation is described as utilizing strain gauges as a means to generate the torque estimate, other sensor types may be used that outperform strain gauges or provide complementary information. For example, accelerometers displaced from aircraft center of gravity can be used to estimate angular acceleration and, in turn, torque. Linear accelerometers are available in a wide variety of sizes and accuracies and are a suitable choice as an alternative, or complementary, source of proprioceptive information. For example, two sets of accelerometers may be used, a first set on either side of the center of gravity and separated by a predetermined distance (e.g., 2-8″, more preferably about 4″) within the fuselage of the aircraft and a second set on the wing tips. Initial testing revealed that the placement of accelerometers inside the fuselage with a 4″ separation and with unfiltered accelerometer data yielded rather limited approximations of the torque. However, the accelerometers on the wing tips more closely approximated the actual torque (when used with a rigid wing). Alternatively, other sensors may be used, such as fiber optic-based strain gauges and capacitive-based sensors. The fiber optic-based strain gauge system uses a single interrogator unit weighing 200 g and a single fiber optic cable to measure strain at stations separated by 0.5-1 m. As described above, the fiber optic strain gauge may be embedded within a groove position on one or more surfaces of the wing (e.g., top, bottom, edges, etc.). Through the use of Bragg grating and wavelength division multiplexing the system can provide strain readings as small as 4.5K microstrain (me) at 3,000 measurements per second. Since the wing of an SUAV is typically smaller than 1 meter in length, the fiber optic cable may be wired in a racetrack pattern (i.e., along the perimeter of the wing or wing set) to achieve several span-wise, distributed measurements. The sensors may be embedded in the wing in an arrangment to best sense strain patterns. For example, the sensors may be evenly distributed, with a higher density of sensors in areas where the strain gradient is high. In certain aspects, pressure sensors can be placed to measure airflow around the wing, airflow relating to the forces being imparted on the wing.

Regardless of the sensor type employed, resulting measurement data may be provided to an aircraft flight control system (whether or not autopilot is employed) early in the sequence of events so as to occur before force and displacement of the aircraft occurs, thus allowing the control system to essentially cancel, or offset, the effect of gusts (e.g., by creating a counterforce or maneuver). For example, consider a non-uniform wind gust that causes the local angle of attack on the right wing to be different from that on the left wing. This difference in angle of attack causes (after some delay) a change in wind circulation on each wing, which results in a rolling moment. The vehicle begins to accelerate in the roll axis, reaching a steady-state roll rate and achieving a non-negligible roll attitude after a few roll subsidence time constants. Thus, there is a second order response between rolling moment and roll attitude, followed by another second-order response between the side force generated by the tilted wing and the actual displacement of the vehicle from its original path. Typical control laws will measure roll attitude and displacement from the desired path and correct these values to maintain track—this latency between actual aircraft positional changes and changes in the Inertial Navigation System (INS) measurements may be too late for effective control. A control system having P-Wing functionality could react directly to the changes in angle of attack, producing a countervailing moment before any significant roll attitude or side displacement occurs.

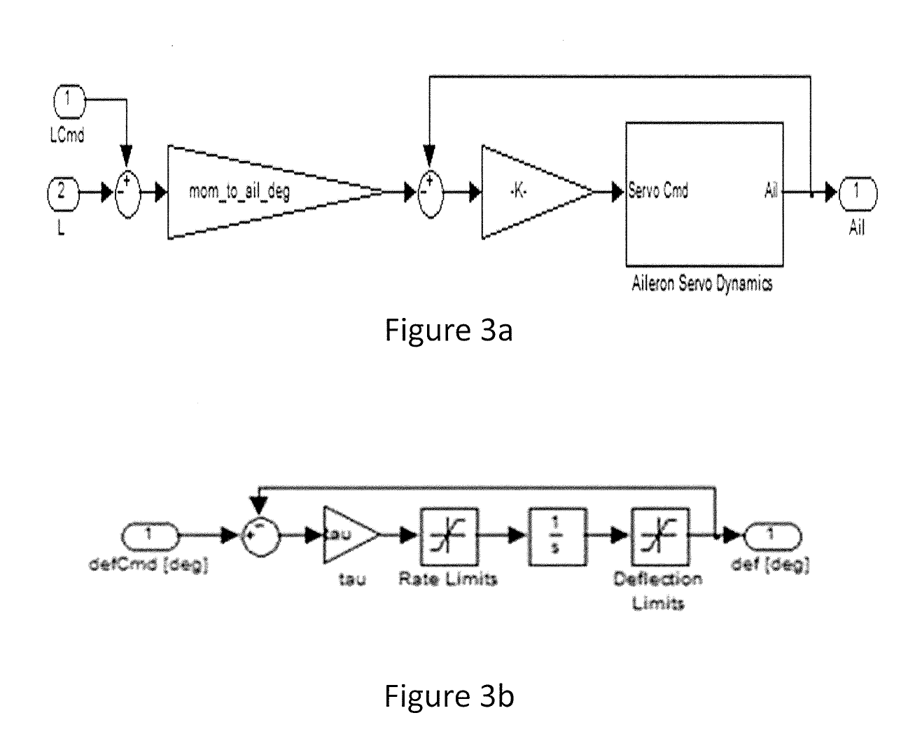

Inner Loop. An example inner loop suitable for use with P-wing is illustrated in FIG. 3a, while FIG. 3b illustrates an example servo dynamics block. A feature of an inner loop is its simplicity, which allows for its implementation in a variety of vehicles with minimal tuning The inner loop enables the system to use spatial weighting patterns to convert instantaneous strain patterns to feedback commands. The design of the spatial weighting patterns enables the system to generate responsive force and moment commands. The integrator in the loop provides robustness to torque biases, disturbances, and vehicle configuration changes, yielding a biomimetic fault tolerance. The performance of this controller, with an outer-loop maintaining straight and level flight, was measured using the RMS error of roll attitude as the metric. Turbulence of 2 m/s (20% of the flight speed) was imposed and an improvement of more than six times was realized.

P-Wing vis-à-vis Conventional Wing Testing. Two control systems were employed to quantify the improvements of P-Wings over conventional wings. The first control system was a conventional controller with decoupled lateral and longitudinal controllers based on standard Global Positioning System (GPS)/Inertial Navigation System (INS) measurement of vehicle attitude, position, and rates. The control system employed a proportional-integral-derivative (PID) control of roll attitude using the ailerons, velocity using the elevator, and altitude using the throttle. The rudder was used to coordinate turns and as a yaw damper. These inner loops were further augmented by outer loops to track a desired path through space using cross-track error feedback to, for instance, roll attitude.

The second, P-Wing-based controller used an entirely different approach for the inner loops, which resulted in much better performance using almost identical outer loops. The inner loop sensors provide not only the current vehicle state, but also the aerodynamic state of the wing (i.e., the angle of attack on the right and/or left wings). Thus wing lift could be predicted as a function of flaperon deflection. Using this information, together with the measured vehicle motion and control surface effectiveness terms, an on-board model was able to compute the full state derivative for any set of control deflections in real time. An optimization procedure used this model to determine the surface deflections required to achieve a desired state derivative. Simpler approaches could also be applied; the important point is that quick reaction in the inner loops significantly improves outer loop performance. The outer loops can rely on the vehicle holding a commanded lift configuration (straight and level or turning) flight in the face of angle-of-attack variations across the wing caused by gusts, thermals, and turbulence. The optimization employed a linear program (LP) on the full non-linear equations of motion of the aircraft, minimizing the difference between the desired and achieved state derivative. Different weights were applied to different states, to ensure that available control power was concentrated on canceling certain types of motion. Surface deflections were also made part of the weighting function, to reduce surface deflections and prevent saturation. Any number of approaches could be used for this optimization; the one chosen here was both expedient and effective for demonstration purposes.

System-Level Benefits. As is common in atmospheric disturbance testing, both discrete and continuously-varying random disturbances were used to evaluate the benefits. To generate realistic, discrete gusts, a single thermal was placed in the path between the waypoints the vehicle was flying. The thermal is modeled as a Gaussian updraft—it induces a vertical wind speed variation which depends (in a Gaussian manner) on the distance to the thermal center. By flying through the edge of a relatively small thermal, large asymmetrical and lateral disturbances are achieved where each wing section “sees” a different part of the thermal as it passes either closer or farther from the thermal's center. This causes the typical glider behavior of “turning away” from the thermal. For continuous gust testing, a Simulink® “Dryden Gust Model” was used. This model generated band-limited gusts consistent with Military Specification MIL-F-8785C. For the tests shown here, light turbulence was used to prevent surface saturation. The quantitative performance measures used for both discrete and continuous testing were cross-track error, attitude deviation (e.g., the aircraft is acting as an ISR sensor platform), and level of wind gust that is sustainable without divergence.

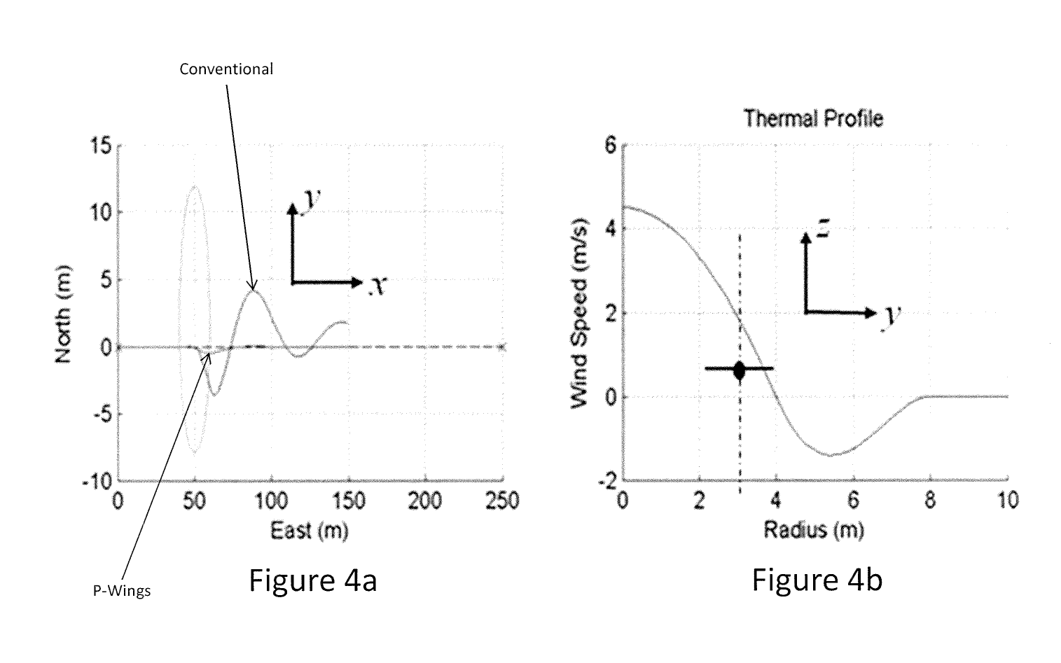

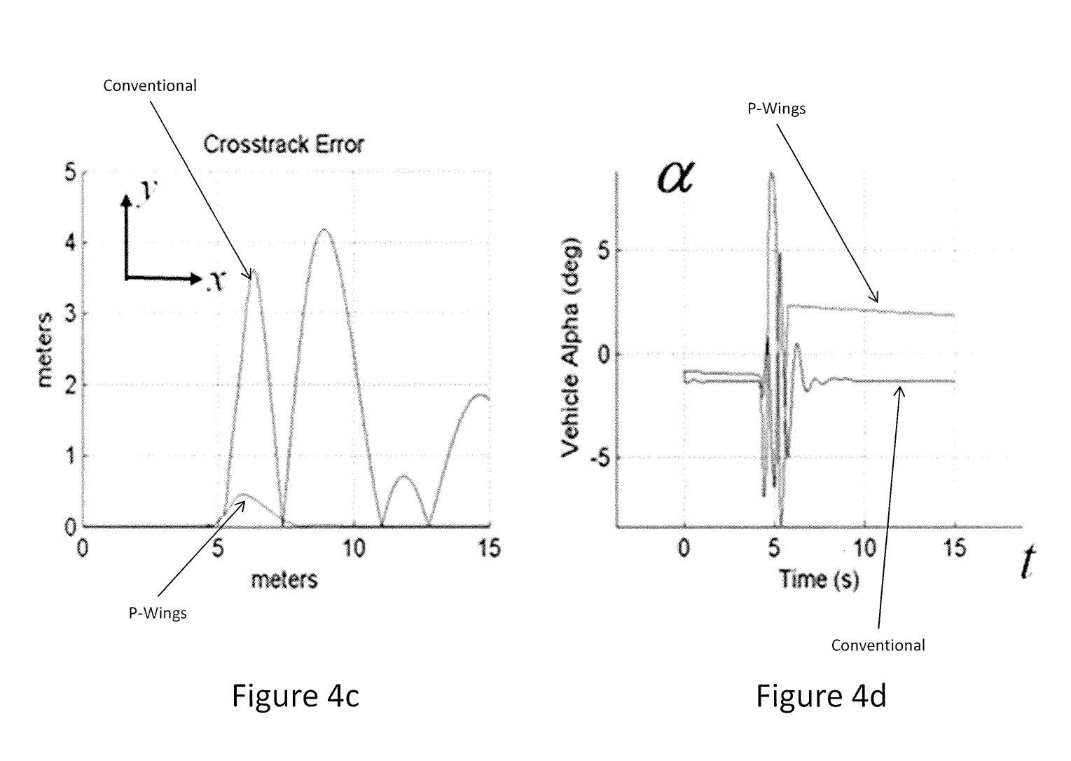

Traversing Thermals. FIGS. 4a through 4d illustrate the results of a thermal encounter. FIGS. 4a and 4b illustrate top and side view of velocity profile. As seen in FIG. 4b, there is approximately a 3 m/s span-wise variation of vertical velocity, which corresponds to about a 15° variation of angle of attack across the span (flight speed is 10 m/s). FIGS. 4c and 4d show that cross-track error, which is reduced from over 4 m to less than 0.5 m, and overall vehicle angle-of-attack variations (these are of less interest than path deviations).

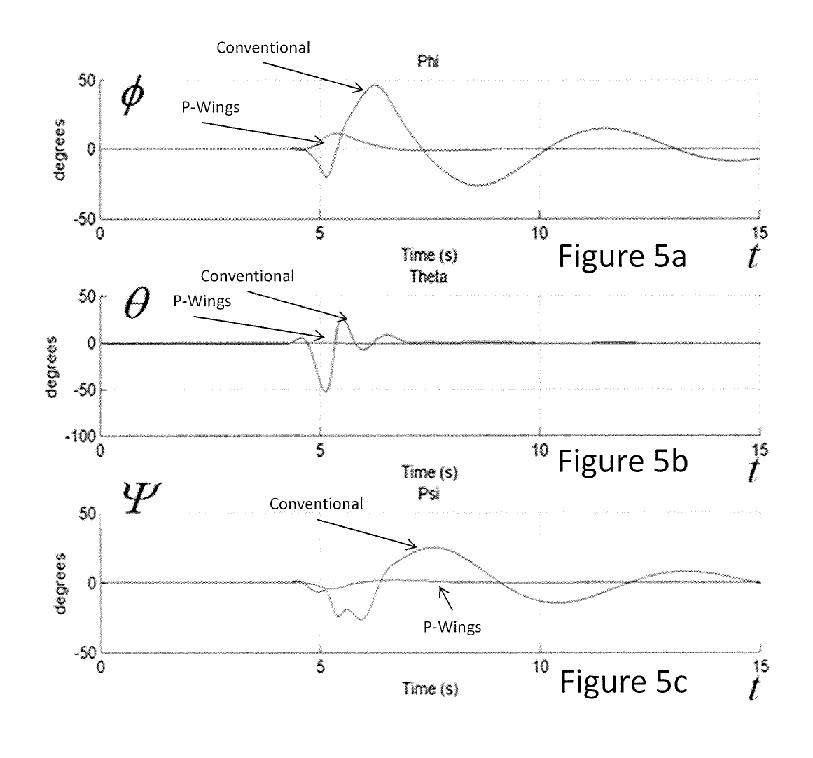

FIGS. 5a through 5c show the attitude deviations during the thermal traverse. As described earlier, the vehicle achieves a high roll attitude (about −20°) before the conventional control system begins to respond (at about five seconds). However cross-track error continues to increase until the roll attitude achieves a restoring attitude; after that both the roll attitude and cross-track error decay in an under-damped manner, consistent with a double-integrator system under PID (rather than full-state) control.

Conversely, the P-Wing system exhibits a much different behavior. The system “detects” that there is a non-uniform angle of attack across the wing and immediately deflects the control surfaces to counteract the rolling moment. Thus the vehicle never exhibits negative roll attitude. However, since there is no direct side-force control, there is a small cross-track error incurred by the optimized control surface deflections. Roll attitude is immediately commanded to a positive value to compensate this offset. Response of roll attitude is “dead-beat,” that is, it does not exhibit overshoot, because full-state knowledge and direct control of roll acceleration is provided by the P-Wing-based controller. Pitch attitude variation is essentially zero, and heading changes are in concert with cross-track error cancellation.

Further, actuator activity increases in the P-Wing case because the surfaces are working together more—if symmetric flaperons are used, the elevator must compensate in pitch. The P-Wing controller is also effectively higher gain because it tracks the commanded roll rate very precisely. However, rudder and throttle commands are significantly reduced in the P-Wing controller, no saturation occurs (all surface deflections are limited to 30°). Overall, the P-Wing implementation yields 85% reduction in cross-track error, even with actuator saturation and relatively large thermals (up to 25% of vehicle airspeed). Noisy sensors did not have a significant impact on the results, and the servo bandwidth and rate requirements are not severe.

Gusts and Turbulence. Two types of random disturbance were also studied: (1) Dryden spectrum gusts that drive the vehicle away from a desired track, and (2) aircraft wake-type gusts that disturb a refueling vehicle from its station-keeping position behind another aircraft. The latter case is simply the two-dimensional version of the first; in both cases band-limited noise is used to represent atmospheric or shed turbulence.

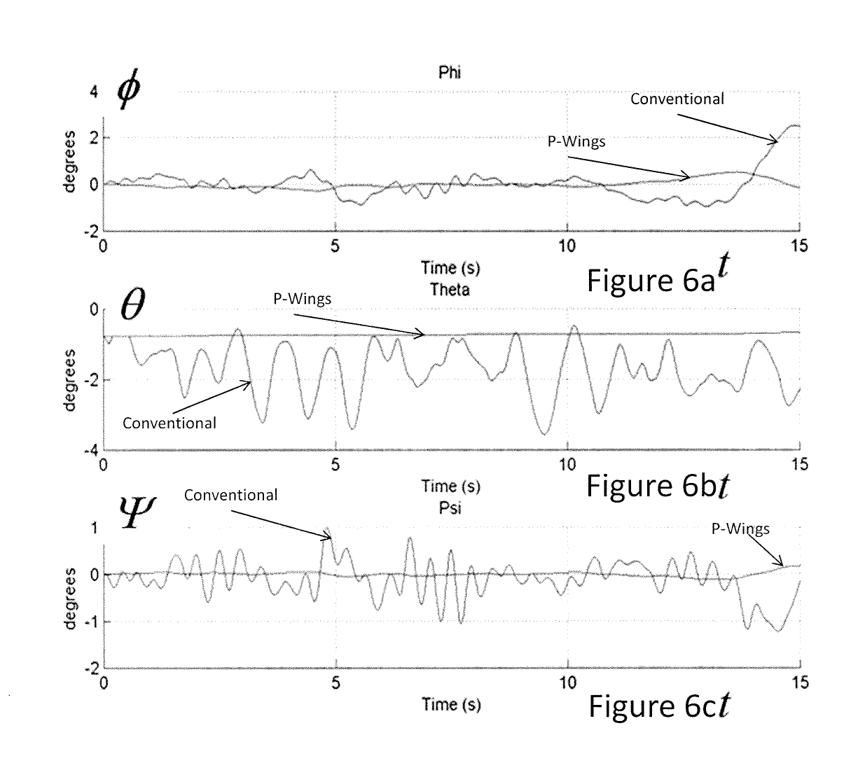

FIGS. 6a to 6c show partial results for relatively light turbulence (e.g., under Dryden spectrum turbulence). Not shown is deviation from track; the conventional controller maintains the desire course with +/−0.4 m of cross-track error, while the P-Wing-enabled system reduces this to +/−0.03 m; essentially perfect tracking This is a result of the direct sensing of the disturbing forces, as well as essentially perfect modeling of the effect of instantaneous angle of attack and flaperon deflection on wing lift. Attitude variations are similarly reduced, from +/−2° to essentially zero using the P-Wing technology. Commanded aileron slew rates, primarily set by the bandwidth properties of the gust, did not exceed 30°/sec for a small vehicle flying through a Dryden gust field. These slew rates are not high compared to current servo technologies which can deliver slew rates of hundreds of degrees per second. Other environments, such as refueling or terminal guidance (seekers), may be more demanding, but even these are not expected to tax the slew rate capabilities of the servos.

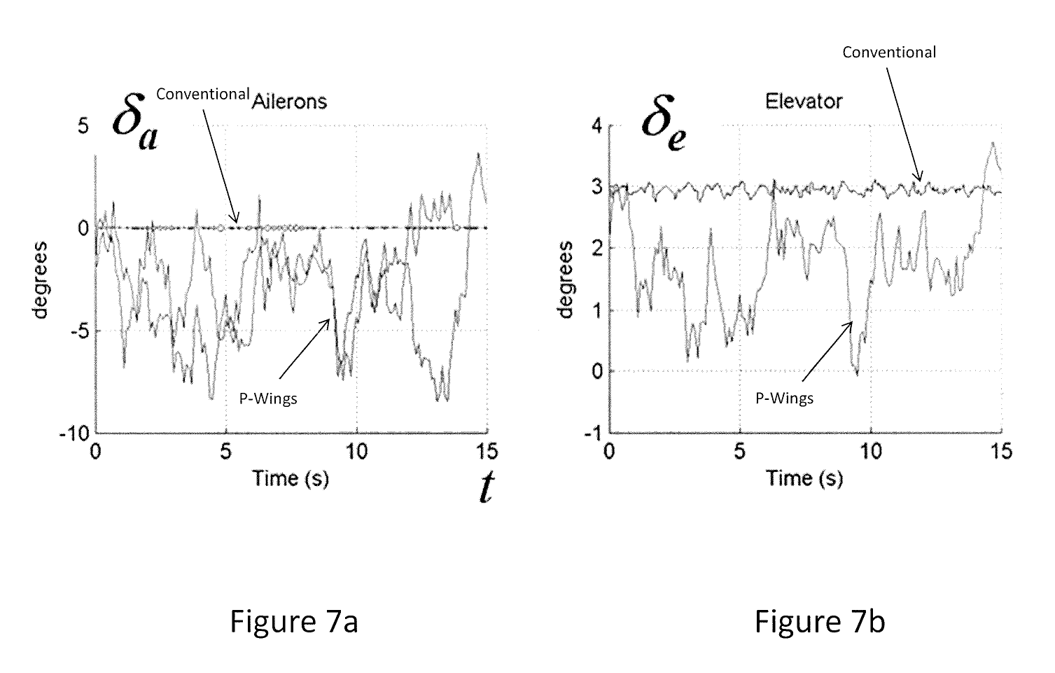

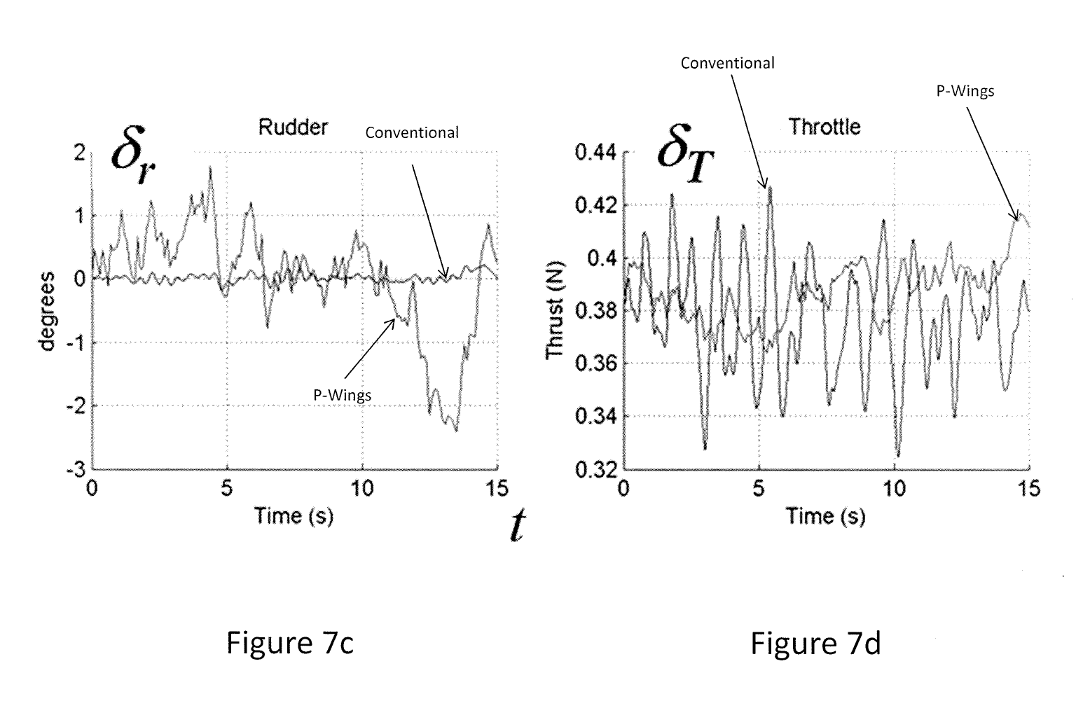

FIGS. 7a through 7d show the surface deflections required to achieve the given tracking results. While these deflections are noisy, they are not extremely large or high bandwidth. More control action is being taken than in the conventional control case. Throttle, however, is reduced in the P-Wing case. Slew rate limits as low as 20°/sec did not substantially degrade performance.

The above results indicate that, with careful aerodynamic modeling and reasonable assumptions on sensor noise, an 85% reduction in cross-track error due to discrete disturbances such as thermal updrafts can be achieved. Actuator saturation and large thermals were incorporated into the analysis. For random gust fields, depending on the axis of interest (yaw, pitch, or roll) 70% to 90% reduction in attitude errors can be achieved. Roll attitude errors tend to be larger because roll attitude deviations are being traded against cross-track error in our simulations.

Any patents, patent publications, or articles cited herein are hereby incorporated by reference in their entirety. It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. An aircraft comprising:
a fuselage;
a plurality of wings,
wherein the fuselage is positioned between a first wing and a second wing,
wherein said first wing and said second wing each comprise (a) a plurality of sensors and (b) a plurality of flaperons; and
a flight controller,
wherein the flight controller is configured to
(1) receive measurement data from each of said plurality of sensors and,
(2) independently actuate each of said plurality of flaperons.

2. The aircraft of claim 1, wherein said one or more of said plurality of sensors provide torque measurement data.

3. The aircraft of claim 2, wherein the flight controller is configured to detect an unwanted force imparted upon the aircraft via said one or more of said plurality of sensors.

4. The aircraft of claim 3, wherein, in response to a detection of an unwanted force, the flight controller actuates one or more of said plurality of flaperons so as to counter the effect of the unwanted force.

5. The aircraft of claim 2, wherein at least one of said plurality of sensors is a strain gauge.

6. The aircraft of claim 5, wherein said strain gauge is a fiber optic strain gauge embedded within a groove of said first wing or said second wing.

7. The aircraft of claim 1, wherein said first and second wings are fabricated using Fused Deposition Modeling.

8. The aircraft of claim 1, wherein said plurality of sensors are positioned along the leading edge of said first and second wings.

9. The aircraft of claim 8, wherein said flight controller uses spatial weighting patterns to convert instantaneous strain patterns to feedback commands.

10. The aircraft of claim 1, wherein said flight controller uses an optimization routine to choose a deflections for each of said plurality of flaperon to achieve a desired wing profile for said first wing or said second wing.

11. The aircraft of claim 1, wherein a separator is positioned between said fuselage and said first wing or said second wing, said separator having a sensor positioned thereon.

12. The aircraft of claim 11, wherein said sensor is a strain gauge.

13. The aircraft of claim 11, wherein said separator is fabricated using a grade G-10 phenolic material.

14. The aircraft of claim 1, wherein said one or more of said plurality of sensors are positioned on the leading edge of said first and second wings.
